(19) United States
(12) Patent Application Publication
(10) Pub. No.: US 2011/0302838 A1
(43) Pub. Date: Dec. 15, 2011

(54) Method And Apparatus For Nurturing Phalaenopsis Orchid Seedlings With Stalk With High Performance of Land Use

(76) Inventors: Yao-Huang Chen, Tainan (TW); Shyh-Shyan Wang, Tainan (TW); Doung-Liang Lin, Tainan (TW); Jung-Jui Cheng, Tainan (TW)

(21) Appl. No.: 13/078,042

(22) Filed: Apr. 1, 2011

(30) Foreign Application Priority Data
Jun. 15, 2010 (TW) 099119441

(51) Int. Cl. A01G 9/02; F21V 33/00

(52) U.S. Cl. 47/65.9; 47/66.7; 362/253

(57) ABSTRACT

The present invention provides a method and an apparatus for nurturing phalaenopsis orchid seedlings with stalk with a high performance of land use, and comprises a nurture room having an air conditioning equipment for a temperature control; a multi-layer planting bed rack installed in the nurture room for placing the phalaenopsis orchid seedlings; and an illumination rack fixed above each planting bed, and having an artificial light source installed thereon for illuminating the phalaenopsis orchid seedlings in the planting beds. With the aforementioned arrangement, the large quantity of phalaenopsis orchid seedlings placed on each planting bed are grown under the conditions controlled at a temperature at 17° C. ˜25° C. and a light intensity of 100˜11000 Lux, so as to achieve the effects of improving the production efficiency, lowering the cost and providing a stable shipping time.

### BACKGROUND OF THE INVENTION

1. Field of the Invention

The present invention relates to a method and an apparatus for nurturing phalaenopsis orchid seedlings with stalk with a high performance of land use, in particular to the method and apparatus that achieve the effects of improving the phalaenopsis orchid turnover rate at room temperature, enhancing the production efficiency, lowering the cost and providing a stable shipping time.

2. Description of the Related Art

Taiwan is a leading country of flow production which earns a large amount of foreign currencies for Taiwan yearly, and phalaenopsis orchid is the largest item in quantity of Taiwan's flower export. After the development of more than ten years, Taiwan's phalaenopsis orchid industry is one of the most important flower industries, and the estimated acreage of standard room-temperature planting is over 200 hectares, and the annual production value may reach up to 3.7 billion NT dollars. Since the mode of international division of labor is adopted for the production in the industry, Taiwan controls a variety of species and has a warm climate suitable for the seedlings breeding, and foreign countries with a low temperature favor the blossom and also constitute a large consuming market, therefore Taiwan's exported phalaenopsis orchids were mainly in form of seedlings without stalk emergency and blossom in the past, and the estimated annual export quantity is up to 40 million seedlings. In recent years, the export market of the phalaenopsis orchid has attempted to sell seedlings with stalk with a height of approximately 5 cm in a pot and has gained excellent responses from the international market. The bedding time at room temperature can be shortened by approximately 30˜45 days for the flower forcing at the end of foreign orchid gardens, not just substantially increasing the turnover rate at room temperature (particularly to the room temperature achieved by long-term heating), but also eliminating customer complaints and disputes with regard to the orchid seedlings without stalk emergency. It is expected that the percentage of the exported seedlings with stalk will be increased gradually in the future. The normal flowering period of the phalaenopsis orchid is concentrated between February and April (after the Lunar New Year) of each year. From May to January (before the Lunar New Year), all exported seedlings with stalk require a special low-temperature environment for emerging peduncles. Therefore, it is a major subject for the flower industry to achieve the effects of nurturing phalaenopsis orchid seedlings, emerging peduncles, lowering costs and providing a stable shipping time efficiently and effectively.

To successfully emerge the peduncle of a general phalaenopsis orchid, appropriate temperature and light are required. However, Taiwan is located at the sub-tropical zone and unable to satisfy the conditions above, and thus it is a common practice for domestic breeders to nurture phalaenopsis orchids by using natural low temperature of mountain lands for forcing stalk. The way of using large-sized air-conditioners to artificially force stalk at a low-temperature plain becomes increasingly more popular. In other words, the room-temperature plain and the mountain area are selectively used for nurturing phalaenopsis orchids. In the setup of room temperature in the plains has the drawback of a high energy consumption, and the artificial low-temperature flowering regulation incurs a significantly high cost, since the air-conditioners are installed to lower the temperature to a standard room temperature in order to produce the seedlings with stalk. In the method of selecting a place for the nurture, the place must have a low-temperature environment required for the production of the phalaenopsis orchid seedlings with stalk, and it was a common practice for domestic breeders to use the natural low temperature of mountain lands at the elevation of 1000˜1200 meters for the flowering regulation in the past. Although this method can save energy, there are several drawbacks as listed below: 1. The seedlings may have a certain percentage of loss during transportation; 2. The reclamation of a room-temperature base in the mountain land incurs a high cost, and breeders indicate that the price is very close to that of the room-temperature body. 3. The nighttime temperature of autumn, winter and spring is too low, and further requires heating in those seasons and incurs a cost for the heating. 4. Building a room-temperature environment in the mountain area has a significant adverse effect on the water and soil conservation and natural scenery, and the transportation and support in the mountain areas are inconvenient; 5. The schedule and the rate of forcing stalk are unstable. Furthermore, the aforementioned two methods still have same drawbacks as follows:
1. It is difficult to control the stalk emergency time and relatively difficult to control the shipping time as specified by buyers.
2. The rate of stalk emergency is unstable. Some are too early, and some are too late, and it takes much effort to pick them for shipment. Sometimes, the shipment rate is not even half
3. The place for the conventional flowering regulation at room temperature generally has an area of 1000 square meters, a height of 3.5 meters, and only one layer of the planting bed, and thus only 28800 plants can be nurtured at full operation, and the production efficiency is very low based on the calculation by a utility rate of 80%. In view of the foregoing drawbacks, the inventor of the present invention proposed the present invention to overcome the drawbacks of the prior art.

### SUMMARY OF THE INVENTION

Therefore, it is a primary objective of the present invention to provide a method and an apparatus for nurturing phalaenopsis orchid seedlings with stalk with a high performance of land use, so as to achieve the effects of improving the room-temperature flower turnover rate, enhancing the production efficiency, lowering the cost, and providing a stable shipping time.

The present invention is characterized in that a nurture room is provided, whose internal temperature is controlled by an air conditioning equipment; a multi-layer planting bed rack is installed in the nurture room, and a large quantity of phalaenopsis orchid seedlings can be placed on each planting bed; and an illumination rack is fixed above each planting bed, and an artificial light source is provided for illuminating the phalaenopsis orchid seedlings placed on the planting bed. With the aforementioned arrangement, the large quantity of phalaenopsis orchid seedlings placed on each planting bed are grown and nurtured under the conditions controlled at a temperature at 17° C.˜25° C. and a light intensity of 100˜11000 Lux, so as to achieve the effects of improving the production efficiency, lowering the cost and providing a stable shipping time.

### BRIEF DESCRIPTION OF THE DRAWINGS

FIG. 1 is a perspective view of a preferred embodiment of the present invention;

FIG. 2 is a front view of a preferred embodiment of the present invention;

FIG. 3 is a side view of a preferred embodiment of the present invention; and

FIG. 4 is a side view of a nurture room without planting beds in accordance with a preferred embodiment of the present invention.

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

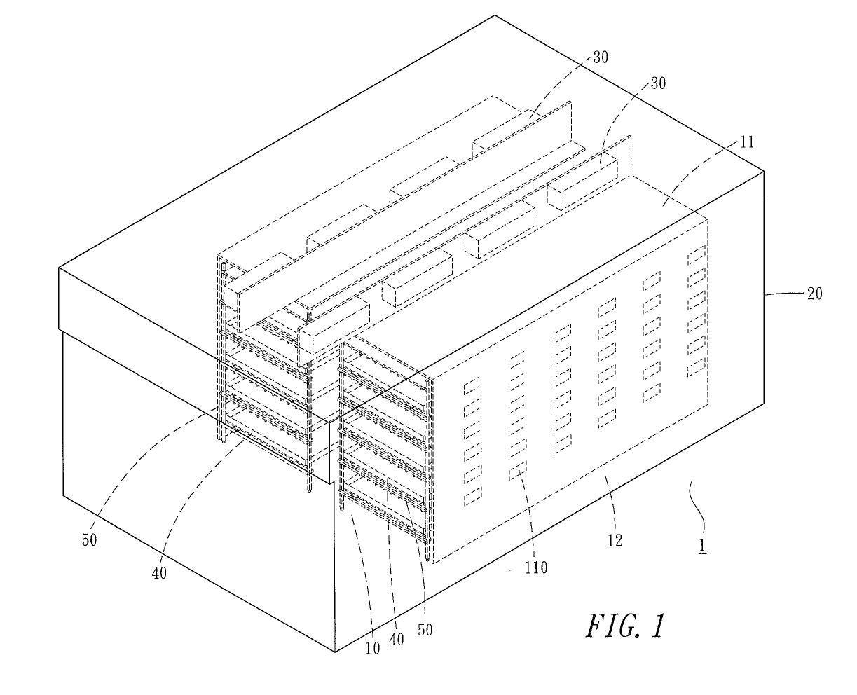

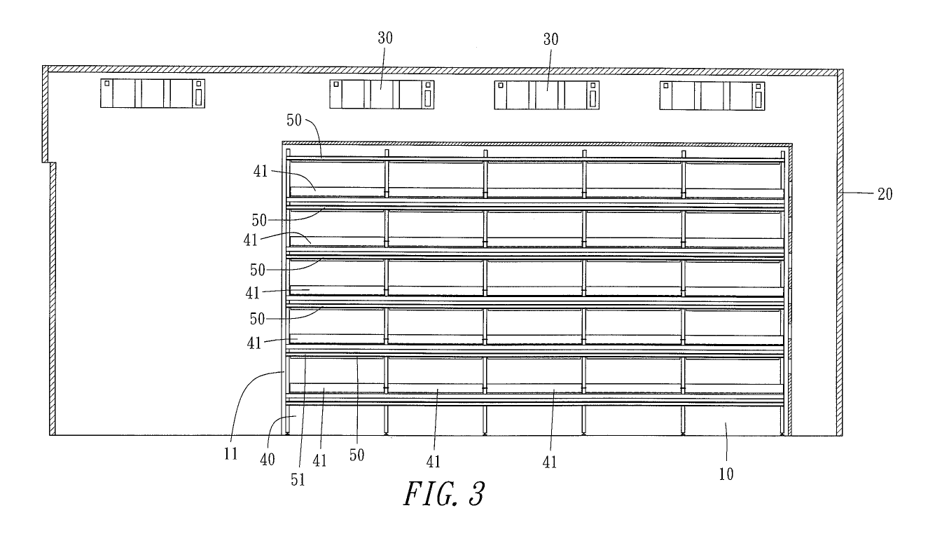

With reference to FIGS. 1 to 3 for a preferred embodiment of the present invention, the preferred embodiment of the present invention comprises a nurture apparatus 1, and a control condition of a phalaenopsis orchid, such that stalks of phalaenopsis orchid seedlings can be emerged successfully in the nurture apparatus 1 at the control condition, wherein the nurture apparatus 1 comprises:

a nurture room 10, having an external wall formed by an insulation board 11 for a partition, and the nurture room 10 being built in a house 20, and the insulation boards 11 on both sides of the nurture room 10 including a plurality of air-conditioning air inlet 110, and a wall of the house 20 being also made of an insulation board 21, and an air conditioning channel 12 being disposed and partitioned between the wall of the nurture room 10 having the air inlet 110 and the wall of the house 20;

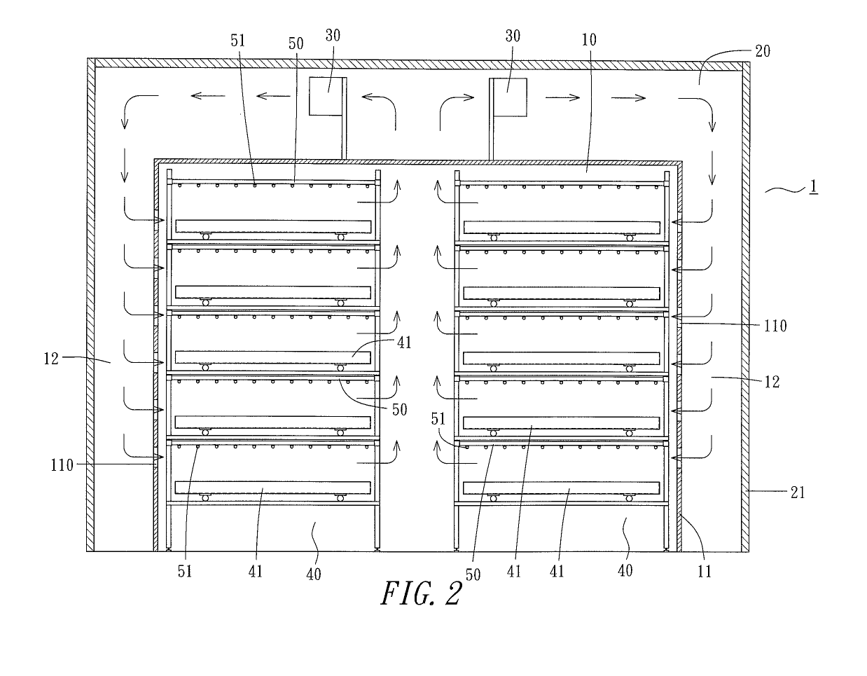

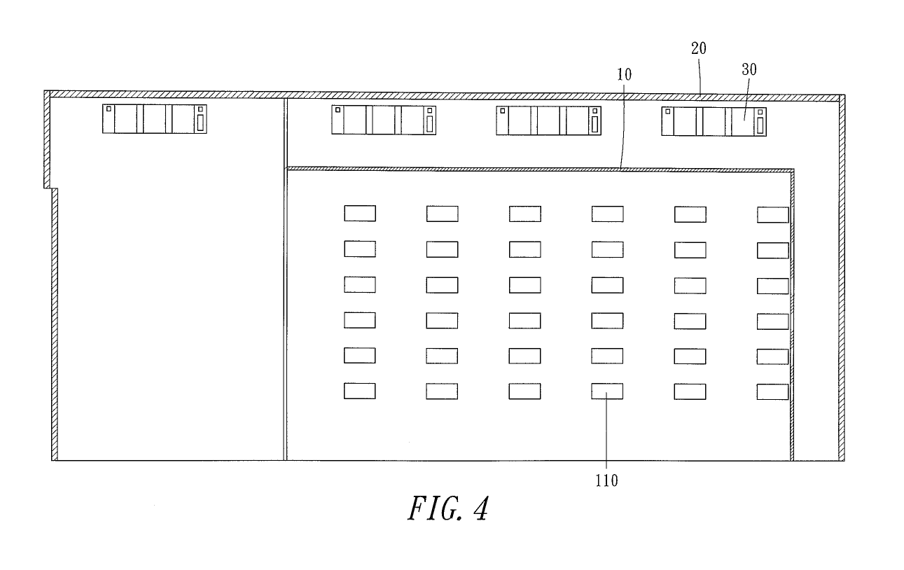

an air conditioning equipment 30, installed at the top of the nurture room 10, and the air outlet and the air conditioning channel 12 being interconnected with each other (as shown in FIGS. 2 and 4), such that air coming out from the air conditioning equipment 30 can enter into the nurture room 10 through the air conditioning channel 12 and the air inlet 110 for controlling the temperature in the nurture room 10;

a multi-layer planting bed rack 40, fixed in the nurture room 10, and having a quantity designed according to the size of the nurture room 10, and each planting bed rack 40 having a plurality of planting beds 41 arranged in layers, and each layer being formed by serially connecting the planting beds 41 from the front to the rear (as shown in FIG. 4), and each planting bed 41 being provided for placing a large quantity of phalaenopsis orchid seedlings; and

an illumination rack 50, fixed at the top of each planting bed 41, and having an artificial light source 51 (such as a lamp and an LED lamp, etc) installed therein for illuminating the phalaenopsis orchid seedlings placed in the planting bed 41, such that the phalaenopsis orchid seedlings of each planting bed 41 can absorb the same light intensity.

During operation, the phalaenopsis orchid seedlings of approximately 2.5 inches to 3 inches are placed all over the planting bed 41 of the each planting bed rack 40, and the air conditioning equipment 30 is adjusted to maintain the temperature in the nurture room 10 within a range of 17° C.˜25° C., and the light intensity of the artificial light source 51 of the illumination rack 50 within a range of 1000 Lux˜11000 Lux, and the peduncles of the phalaenopsis orchid seedlings can be emerged in the nurture room 10 under the aforementioned temperature and light intensity in approximately one month and ready for shipping.

Since the large quantity of phalaenopsis orchid seedlings are disposed on the plurality of planting beds 41 arranged in layers in the nurture room 10, the temperature and the light intensity are adjusted and controlled according to the characteristics of the phalaenopsis orchid, and the design of the multilayer planting bed 41 improves the utility of hardware equipments and the production efficiency, lowers the cost, adjusts the temperature and light intensity of the phalaenopsis orchid, stabilize the shipping time, and increase the turnover rate of the nurture room 10.

The present invention focuses at the issues of energy saving and high land use performance, and uses the stalk forcing equipment of the seedlings with stalk and isolates the sunlight from entering, and adopts the artificial light source (with an illumination rack 50 and an artificial light source 510 to save the cost for lowering the temperature. With the design of the multi-layer planting bed 41, the utility rate of hardware equipments can be improved, and a novel technology for producing the seedlings with stalk is introduced. The innovations of this technology are listed below:
1. The artificial light source replaces the sunlight for emerging the peduncle, and the quality of blossom is similar. In addition, the power consumption can be saved significantly by simply eliminating a small quantity of heat from the artificial light source.
2. Compared with the conventional room-temperature flowering regulation only having a layer of bedding rack, the stalk forcing equipment of the present invention adopts a multi-layer design of planting beds 41, and the number of stalk forcing per unit area can be increased significantly, and the cost for the hardware equipment for nurturing the seedlings can be lowered. The stalk forcing equipment for the seedlings with stalk in accordance with the present invention comes with a phalaenopsis orchid nurture apparatus is a five-layer rack with an area of 1000 square meters and a height of 3.5 meter, so that 144000 plants can be planted at a full operation, based on the calculation of 80% of the utility rate. Using 1.5 months as a turnover for example, 1152000 peduncles can be produced yearly (compared with the conventional room-temperature flowering regulation using a room-temperature nurture room with an area of 1000 square meters, a height of 3.5, and only one layer of the planting bed, and only 28800 plants can be planted at a full operation, based on the calculation by the utility rate of 80%), and the difference of the selling prices between the seedlings with stalk and the seedlings without stalk is 20 NT dollars, and thus a value of 23.04 million NT dollars can be created.
3. Compared with the room-temperature flowering regulation with a temperature controlled at 24° C. at daytime, and 18° C. at nighttime, the present invention adopts different temperature controls to achieve the effect of forcing stems.
4. The present invention does not require any manual management operation during the period from the entrance of the seedlings on the planting bed rack into the warehouse to the exit of the seedlings from the warehouse. The test results of over 45 species with different colors show that the peduncles can be emerged within 15˜42 days. The plant is moved to a place for the normal room-temperature flowering regulation after the stalk is emerged, and the growth and blossom quality of the plant is observed. The result shows that the room-temperature flowering regulation method has similar effects.

In summation of the description above, the method of nurturing seedlings with stalk in accordance with the present invention improves over the prior art and complies with the patent application requirements, and is thus duly filed for patent application.

What is claimed is:

1. A method of nurturing phalaenopsis orchid seedlings with stalk with a high performance of land use, comprising:
providing a nurture room with an air conditioning equipment installed therein and provided for a temperature control;
providing a multi-layer planting bed rack installed in the nurture room, and each planting bed rack having a plurality of planting beds arranged in layers, and the planting beds being provided for placing the phalaenopsis orchid seedlings; and
providing an illumination rack fixed above each planting bed and having an artificial light source installed thereon for illuminating the phalaenopsis orchid seedlings in the planting beds;
placing the phalaenopsis orchid seedlings in the planting beds of the planting bed rack, and adjusting the air conditioning equipment to maintain the temperature in the nurture room between 17° C. and 25° C., and adjusting the light intensity of the artificial light source of the illumination rack to maintain the light intensity between 1000 Lux and 11000 Lux, such that after a nurture time, a peduncle of the phalaenopsis orchid is emerged from the phalaenopsis orchid seedlings in the nurture room controlled at the condition of said temperature and said light intensity.

2. An apparatus of nurturing phalaenopsis orchid seedlings with stalk with a high performance of land use, comprising:
a nurture room, having an air conditioning equipment installed therein and provided for a temperature control;
a multi-layer planting bed rack, installed in the nurture room, and each planting bed rack having a plurality of planting beds arranged in layers, and the planting beds being provided for placing the phalaenopsis orchid seedlings; and
an illumination rack, fixed above each planting bed, and having an artificial light source installed thereon for illuminating the phalaenopsis orchid seedlings in the planting beds.

3. The apparatus of nurturing phalaenopsis orchid seedlings with stalk with a high performance of land use as recited in claim 2, wherein the nurture room wall is built by an insulation board, and the nurture room is located in a house.

4. The apparatus of nurturing phalaenopsis orchid seedlings with stalk with a high performance of land use as recited in claim 3, wherein the house wall is built by an insulation board, and an air conditioning channel is formed and partitioned between the house wall and the nurture room wall, and the nurture room wall includes a plurality of air-conditioning inlet, and the air conditioning equipment is installed at the top of the nurture room, and the air outlet is interconnected to the air conditioning channel, such that the air controlled and blown from the air conditioning equipment enters into the nurture room through the air conditioning channel and the air inlet.

5. The apparatus of nurturing phalaenopsis orchid seedlings with stalk with a high performance of land use as recited in claim 2, wherein each layer of the multi-layer planting bed rack is formed by serially connecting the planting bed arranged from the front to the rear.

6. The apparatus of nurturing phalaenopsis orchid seedlings with stalk with a high performance of land use as recited in claim 2, wherein the artificial light source is a lamp.
